(19) United States
(12) Patent Application Publication
(10) Pub. No.: US 2014/0084662 A1
(43) Pub. Date: Mar. 27, 2014

(54) One Piece Back Frame With An Integrated Back Panel

(71) Applicants: Ornela Zekavica, Northville, MI (US); Miodrag Mitch Petrovich, Ann Arbor, MI (US)

(72) Inventors: Ornela Zekavica, Northville, MI (US); Miodrag Mitch Petrovich, Ann Arbor, MI (US)

(21) Appl. No.: 13/992,340

(22) PCT Filed: Dec. 21, 2011
(86) PCT No.: PCT/US2011/066397

§ 371 Date: Dec. 9, 2013

Related U.S. Application Data
(60) Provisional application No. 61/425,424, filed on Dec. 21, 2010.

(51) Int. Cl. B60N 2/64; B60N 2/68; B60N 2/58

(52) U.S. Cl. CPC B60N 2/64; B60N 2/58; B60N 2/68
USPC 297/452.18; 29/428

(57) ABSTRACT

A front row vehicle seat including a back frame, a core and a trim cover. The back frame has a generally rectangular shape presenting an upper portion, a lower portion, a pair of vertical portions. The entire back frame is formed of one piece of metal, and thus, the portions are all integrally connected together. The core and trim cover are disposed about the back frame to provide a comfortable seating surface for an occupant of the vehicle.

### CROSS-REFERENCE TO PRIOR APPLICATION

This U.S. National Stage Patent Application claims the benefit of International Application serial number PCT/US11/66397 filed Dec. 21, 2011, entitled “One Piece Back Frame With An Integrated Back Panel” and U.S. Provisional Patent Application Ser. No. 61/425,424 filed Dec. 21, 2010, entitled “One Piece Back Frame with an Integrated Back Panel,” the entire disclosures of the applications being considered part of the disclosure of this application, and hereby incorporated by reference.

### BACKGROUND OF THE INVENTION

1. Field of the Invention

The present disclosure relates generally to the field of vehicle seating. More specifically, this disclosure relates to a one-piece back frame for a vehicle seat including an integrated back panel.

2. Brief Description of the Related Art

The seat back of most vehicle seats includes three primary components: a back frame, a foam core and a trim cover. Typical back frames include a generally rectangular metal piece with an open interior and a backing plate, usually of plastic, disposed in the opening. The back panel provides a rigid planar surface exposed toward the back of the vehicle that helps protection and also provides a table surface when the seat is folded forwardly.

One design of a known back frame 20 is generally shown in FIG. 1. As discussed above, this back frame 20 includes a generally rectangular metal piece 22 and a plastic back panel 24. The metal piece 22 is formed completely from a blank 26 of sheet metal, which is shown in FIG. 2. To form the bank 26 into the shape shown in FIG. 1, the blank 26 is put through a first sheet metal drawing process to define the rectangular shape discussed above. Following the first sheet metal drawing process, the metal piece 22 defines a center portion 28, which is best shown in FIG. 3. This center portion 28 is removed through a cutting or punching process to produce the metal piece 22 shown in FIG. 4. The metal piece 22 is then put through a second sheet metal drawing process to further define the final shape of the metal piece 22, which is shown in FIG. 5. Certain zones of the metal piece 22 are then restriked for welding or brazing to other components (not shown), such as a reclining mechanism. Additionally, extra material in the back of the metal piece 22 is bent inwardly to present flanges (not shown) for supporting a core (not shown) of a foam material inside of the metal piece 22. FIG. 6 shows the metal piece 22 during the restriking and bending process, and FIG. 7 shows the metal piece 22 after the restriking and bending process has been completed.

Next, a plurality of holes 30 are pierced into the metal piece 22 for providing attachment components for even more components, such as a head restraint. FIGS. 8 and 9 show the metal piece 22 after some of the holes 30 have been pierced. Once all of the holes 30 are pierced and the edges formed, the plastic back panel 24 is attached to the opening created when the center section 28 was removed. The back panel 24 is typically attached to the metal piece 22 with a plurality of retaining members 31.

In order to meet strict strength requirements for the back frame 20 to be certified for use in passenger vehicles, the plastic back panel 24 must be made very thick, which is undesirable for cost and weight purposes. Driven by craftsmanship, attaching points between the back panel 24 and the back frame 22 are usually not visible during the installation process. This makes the assembly process difficult.

There remains a significant and continuing need for improved back frames for vehicle seats which are strong, light and cost effective.

### SUMMARY OF THE INVENTION

One aspect of the subject invention is for a vehicle seat including a back frame presenting an upper portion, a lower portion a pair of vertical portions and a center portion all of one piece of material and integrally connected to one another. A core and a trim cover are disposed about the back frame to provide a comfortable seating surface for an occupant of the vehicle. The back frame is preferably of a high strength, thin gauge steel, which allows it to meet the strength requirements for use in passenger vehicles. The present invention meets these strength requirements without compromising on the weight or cost of the vehicle seat. In fact, depending on the type and thickness of the steel chosen, the integrated back panel could have the same or less mass than a comparable thicker plastic back panel.

This aspect of the invention is also advantageous because it minimizes the amount of material that is wasted during the manufacturing of the back frame. In other known back frames, the material which is removed from the center portion of the metal piece is either disposed of or recycled. In contradistinction, this material is directly used in the present invention to strengthen the back frame.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a back view of a back frame including a separate back panel;

FIG. 2 is a top view of a sheet metal blank to be formed into a back frame;

FIG. 3 is a perspective view of the back frame after a first sheet metal drawing step;

FIG. 4 is a top view of the back frame after a trimming step;

FIG. 5 is a perspective view of the back frame after a second sheet metal drawing step;

FIG. 6 is a perspective view of the back frame after a first restriking step;

FIG. 7 is a top view of the back frame after a second restriking step;

FIG. 8 is a perspective view of the back frame after a first piercing step;

FIG. 9 is a perspective view of the back frame after a second piercing step;

FIG. 10 perspective and elevation view of an exemplary back frame;

FIG. 11 is a cross-sectional view of the exemplary back frame taken along Line 11-11 of FIG. 10 and further including a foam core and a trim cover;

FIG. 12 is a perspective and elevation view of the exemplary back frame after a striking process;

FIG. 13 is a top view of the exemplary back frame after the striking process;

FIG. 14 is a perspective and elevation view of the exemplary back frame;

FIG. 15 is a cross-sectional view of the exemplary back frame taken along Line 15-15 of FIG. 14; and

FIG. 16 is a cross-sectional view of the exemplary back frame taken along Line 16-16 of FIG. 14.

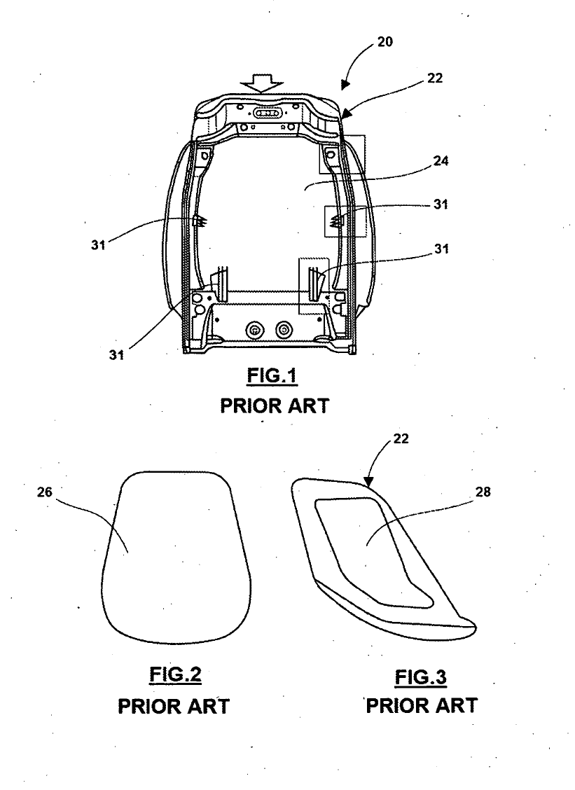

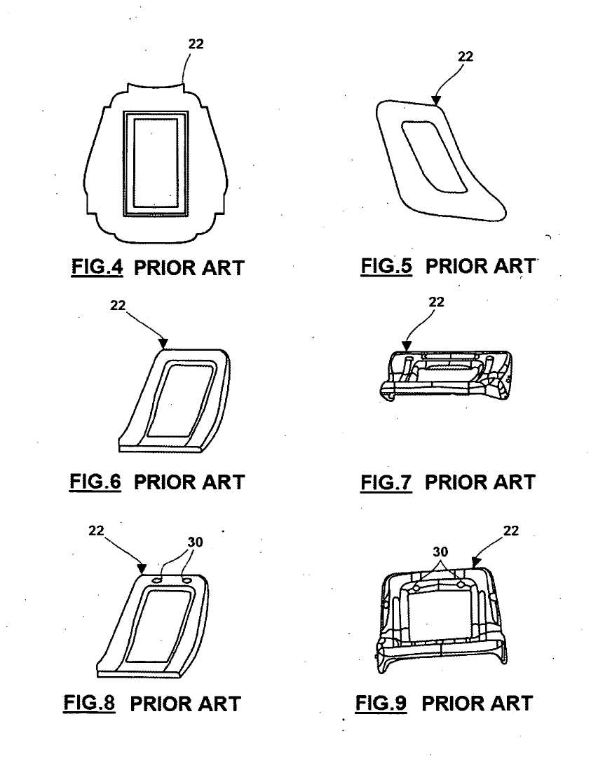

### DETAILED DESCRIPTION OF A PREFERRED EMBODIMENT

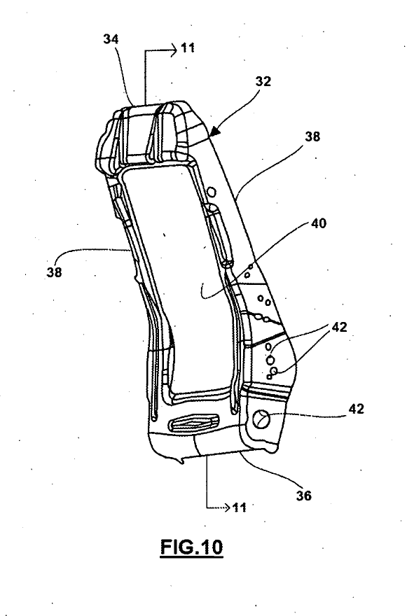

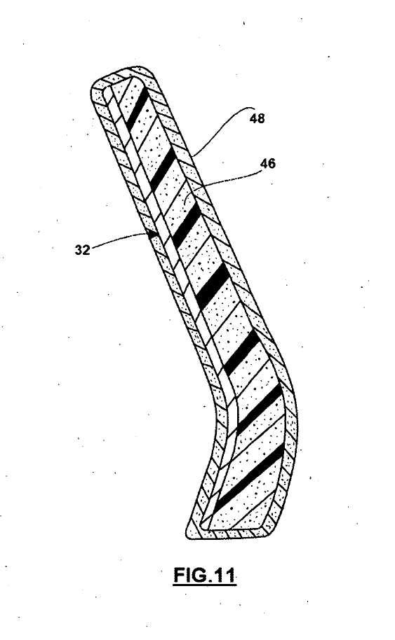

Referring to the Figures, wherein like numerals indicate like or corresponding parts throughout the several views, an exemplary a back frame 32 for a vehicle seat according to one aspect of the invention is generally shown in FIG. 10. The back frame 32 is preferably for a front row seat of a passenger vehicle, such as a car, a van, a truck or a sport utility vehicle. However, it should be appreciated that the back frame 32 could find uses in other types of vehicles including, for example, airplanes, trains or boats.

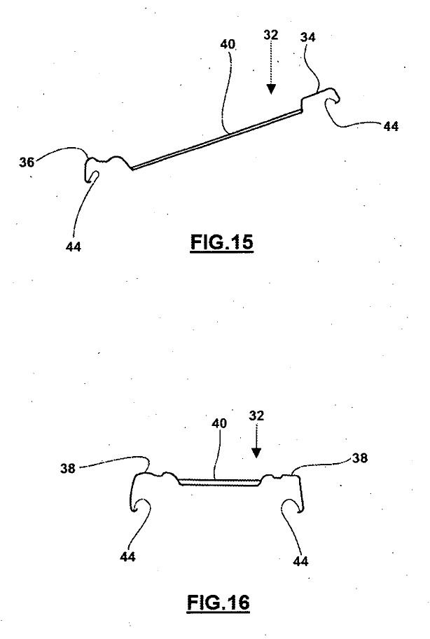

The back frame 32 includes an upper portion 34, a lower portion 36 and a pair of vertical portions 38 arranged to present a generally rectangular shape. The back frame 32 also includes a center portion 40 disposed between and integrally connected to the upper, lower and vertical sections. The upper and vertical portions 34, 38 each include a plurality of holes 42 which serve as attachment points for additional components components, such as a recliner mechanism, a seat heater, a lumbar mechanism or a head restraint. Referring now to FIGS. 15 and 16, the upper, lower and vertical portions 34, 36, 38 each are folded inwardly to present a plurality of flanges 44 for holding a core 46 of foam, as will be discussed in further detail below.

The entire back frame 32 is formed of one piece of metal, and thus, the upper, lower, vertical and center portions 34, 36, 38, 40 are all integrally connected to one another. The single piece of metal may be, for example, 0.8 mm thick AHSS-Dual Phase steel. However, it should be appreciated that the back frame 32 could be of a range of different metals and could have any desirable thickness. The exemplary back frame 32 is shaped such that the center portion 40 has a height in the range of 420-450 mm and a width in the range of 200-230 mm However, it should be appreciated that the center portion 40 could have any desirable height or width.

Referring now to FIG. 11, the exemplary back frame 32 discussed above is shown in a front row vehicle seat. The vehicle seat includes a core 46 of a foam material and a trim cover 48, and at least the trim cover 48 substantially entirely surrounds the back frame 32. The core 46 is preferably of a foam material, such as polypropylene, polyurethane or expanded polypropylene, and the trim cover 48 is preferably of fabric or leather. However, these components could be formed of a wide range of materials.

Another aspect of the invention provides for a method of forming the exemplary back frame 32 discussed above. The method starts with the step of providing a blank of sheet metal. As discussed above, the exemplary sheet metal is preferably 0.8 mm thick AHSS-Dual Phase steel, but the sheet metal could be of any desirable type of metal and could have any desirable thickness.

The exemplary method continues with the step of drawing the sheet metal in a die to give the sheet metal a generally rectangular shape having an upper portion 34, a lower portion 36, a pair of vertical portions 38 and a center portion 40 all being integrally connected to one another. The center portion 40 is not removed from the back frame 32, but instead remains an integral component therewith. Because the center portion 40 is not removed from the back frame 32, less material is wasted in manufacturing the exemplary back frame 32 when compared to other known back frames 32. The center portion 40 improves the structural integrity of the back frame 32.

Depending at least partially on the complexity of the final design of the back frame 32, the type of metal being used and the thickness of the material, it may not be possible to achieve the final overall shape of the back frame 32 through only a single drawing process. Therefore, the exemplary method continues with another step of drawing the now-shaped material in a die to give the material its final overall shape. However, it should be appreciated that any desirable number of drawing processes could be used to shape the back frame 32. It may also be desirable to machine or grind portions 34, 36, 38, 40 of the back frame 32 at this point to further shape the back frame 32.

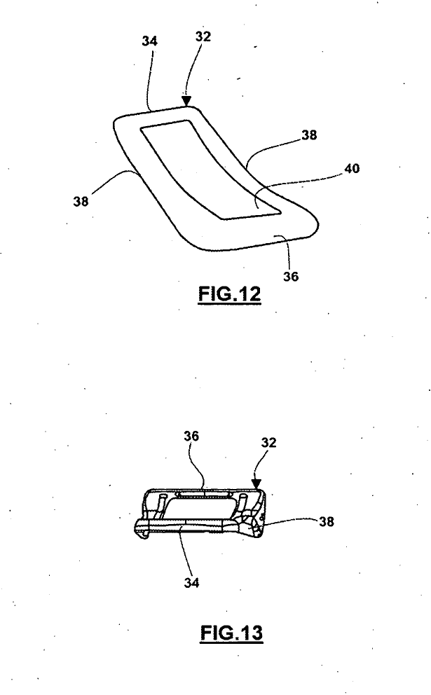

Once the second sheet metal drawing process is complete, the exemplary method proceeds with the step of striking certain zones of the back frame 32 to prepare those zones for welding or brazing to other components. The striking can be done with a hammer, or any blunt object, and has the effect of smoothing out those surfaces to prepare them for welding or brazing with the other components such as, for example, a reclining mechanism (not shown). Referring now to FIGS. 12 and 13, the exemplary back frame 32 is shown following the striking process.

The exemplary method then continues with the step of bending extra material on the back of the upper and vertical portions 34, 38 inwardly to present flanges 44 for holding the foam core 46 in the back frame 32. The flanges 44 are best shown in FIGS. 15 and 16.

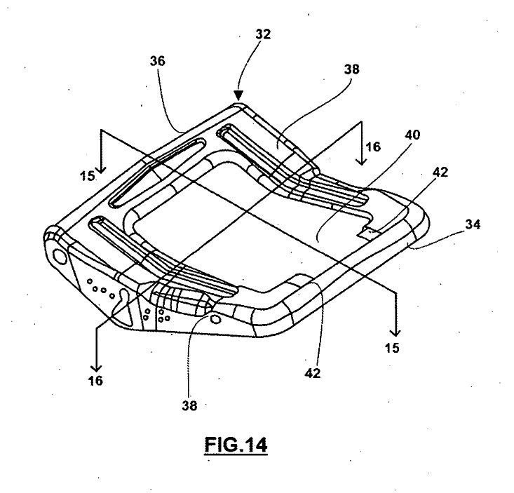

Next, the exemplary method continues with the step of forming a plurality of holes 42 in the upper and vertical portions 34, 38 of the back frame 32. The holes 42 could be formed through any desirable process including, for example, punching, piercing or cutting. Referring now to FIG. 14, the exemplary back frame 32 is shown after the holes 42 in the vertical portions 38 and the upper portion 34 have been punched. As shown, the holes 42 in the upper portion 34 are square-shaped, which might be preferred for receiving tubes that interconnect the back frame 32 with a head restraint.

Finally, the exemplary method includes the step of coating the back frame 32 with a protective material. The material could be, for example, a rust preventative coating or a coating for improving the bond between the back frame 32 and the core 46.

The foregoing invention has been described in accordance with the relevant legal standards, thus the description is exemplary rather than limiting in nature. Variations and modifications to the disclosed embodiment may become apparent to those skilled in the art and fall within the scope of the invention.

We claim:

1. A method of forming a vehicle seat, comprising the steps of:
providing a blank of metal;
shaping the blank to present an upper portion, a lower portion, a pair of vertical portions and a center portion all integrally connected to one another to present a back frame; and
inserting a trim cover over the back frame including the center portion.

2. The method as set forth in claim 1 wherein the step of shaping the blank includes the step of drawing the blank in a die to present the upper, lower, vertical and center portions.

3. The method as set forth in claim 1 wherein the step of shaping the blank further includes the step of bending the material of the upper, lower and vertical portions to present flanges for holding a foam core.

4. The method as set forth in claim 1 wherein the step of shaping the blank further includes the step of striking predetermined portions of the back frame to provide smooth surfaces for welding or brazing.

5. The method as set forth in claim 1 wherein the step of shaping the blank further includes the step of forming a plurality of holes into at least one of the upper, lower and vertical portions of the back frame.

6. The method as set forth in claim 5 wherein the step of forming the plurality of holes is further defined as punching, piercing, or cutting the holes into at least one of the upper, lower and vertical portions of the back frame.

7. The method as set forth in claim 1 further including the step of coating the back frame with a protective material before the step of inserting the trim cover over the back frame with the trim cover.

8. A vehicle seat comprising:
a back frame presenting an upper portion, a lower portion, a pair of vertical portions and a center portion all being of one piece of material and being integrally connected to one another; and
a core and a trim cover disposed about said back frame.

9. The vehicle seat as set forth in claim 8 wherein said back frame is of metal.

10. The vehicle seat as set forth in claim 9 wherein said back frame is of steel.

11. The vehicle as set forth in claim 10 wherein said steel of said back frame is ADHD Dual Phase steel.

12. The vehicle seat as set forth in claim 8 wherein at least one of the upper, lower and vertical members presents a flange.

13. The vehicle as set forth in claim 8 wherein said core is of foam.

14. The vehicle as set forth in claim 13 wherein said foam of said core is polypropylene, polyurethane or expanded polypropylene.

15. The vehicle as set forth in claim 8 wherein said trim cover is of fabric or leather.
